(19) United States
(12) Patent Application Publication
(10) Pub. No.: US 2008/0064663 A1
(43) Pub. Date: Mar. 13, 2008

(54) Melt processing of phosphoroamido(di)thioate insecticides

(76) Inventor: Jesse H. Gaytan, Valdosta, GA (US)

Correspondence Address: PILLSBURY WINTHROP SHAW PITTMAN LLP, ATTENTION: DOCKETING DEPARTMENT, P.O BOX 10500, McLean, VA, 22102, US

(21) Appl. No.: 11/518,486

(22) Filed: Sep. 11, 2006

(51) Int. Cl. A01N 57/00; B29B 9/00

(52) U.S. Cl. 514/114; 424/405; 264/5

(57) ABSTRACT

An insecticide solid or particulate is produced from a phosphoroamido(di)thioate insecticide such as acephate. The particulate insecticide is formed by melting the insecticidal solids in a substantially oxygen-free, and preferably moisture free, atmosphere to prevent oxygen entrainment in the resulting melt to inhibit later degradation upon storage. The melt is formed into granules, extrudates, prills, flakes, shaped briquettes, or other shapes as desired.

### FIELD OF THE INVENTION

The invention relates to a process for forming solid forms of phosphoroamido(di)thioate-type insecticides, such as acephate, from technical grade, crystalline forms of the active ingredient into prills, flakes, pellets, or similarly sized macroparticulate solids.

### BACKGROUND OF THE INVENTION

N-hydrocarboyl phosphoroamidothioates and phosphoroamidodithioates (referred to herein as “phosphoroamido(di)thioates”) are classes of particularly heat sensitive compounds that are used as systemic insecticides in a variety of environments. One of the most commercially important compounds within this class is acephate. Acephate and related compounds are described in U.S. Pat. No. 3,716,600, U.S. Pat. No. 3,845,172 and U.S. Pat. No. 3,914,417 the disclosures of which are herein incorporated by reference.

As obtained commercially, technical grade acephate is available in a crystalline form having a length to diameter (L/D) ratio of about 4 to about 10, depending on the size reduction process. Such crystals are, however, hygroscopic and tend to form clumps and agglomerates of inconsistent sizes. Thus, acephate technical is usually ground or milled to form a powder of consistent particle size distribution.

Acephate is, however, problematic to grind due to the frictional heat inherent in most grinding processes. Experience has found that grinding of acephate technical should only be undertaken in relatively cool weather, such as Fall and Winter seasons, or in an air conditioned facility with a fairly low temperature setting.

As described in published U.S. Patent Application No. 2005/0163814 and herein incorporated by reference, jet milling produces a technical grade of acephate that exhibits a consistent, narrow range of particle sizes with certain advantages in the formation of larger granules from the milled solids.

Even when ground or milled to an acceptably narrow range of average particle sizes, further processing to form useful granules has also been fraught with technical difficulties.

A number of patents for processes to manufacture pelleted or granular acephate. U.S. Pat. No. 5,075,058 describes phosphoroamido(di)thioate pellets with a second active ingredient (insecticide, fungicide, herbicide, or fertilizer), a surfactant that is used to encapsulate the phosphoroamido(di)thioate active, an anhydrous magnesium sulfate as a dehydrating agent to absorb moisture and prevent hydrolysis of the phosphoroamido(di)thioate, a deodorant, and an anti-foaming agent. The mix is extruded through a die at 30° to 40° C. and dried.

U.S. Pat. No. 5,100,667 describes a solvent-free method for making phosphoroamido(di)thioate pellets that relies on a dry mix with a solid surfactant to provide structural integrity. The example shows the use of ammonium sulfate in addition to the phosphoroamido(di)thioate and surfactant.

U.S. Pat. No. 5,298,501 describes the use of 83-98 wt % ammonium sulfate for providing integrity to granules containing 2-17 wt % of a phosphoroamido(di)thioate.

U.S. Pat. No. 5,352,674 discloses a formulation containing a phosphoroamido(di)thioate, an optional second active ingredient (e.g., a fungicide), at least 75 wt % of ammonium sulfate, 0.2-5 wt % of a surfactant, 0.05-2 wt % of a deodorant, and 1-5 wt % of granular processing aids that are selected from a lubricant (Mg stearate, Ca stearate, Zn stearate, and silicon emulsions) in an amount within the range of 0.5-5 wt %, a binder (corn starch, polymers, and natural gums), and 0.5-5 wt % of a flowability aid (colloidal silica, and micronized clay). All examples use significant quantities of ammonium sulfate to form a structural granule. Indeed, Example 3 of the '674 patent illustrates the adverse storage effects of formulations that do not contain ammonium sulfate.

U.S. Pat. No. 5,369,100 is directed to a formulation that does not use a binder. Instead, the formulation relies on compaction of a mix containing the technical form of the active and ammonium sulfate. Lubricants (Mg stearate) and flow aids (silica particles) are also added to the formulation as shown in the examples.

U.S. Pat. No. 6,013,272 teaches the manufacture of water-free phosphoroamido(di)thioate granules without added solvent by heating the extrusion die to a temperature that is sufficient to soften the active solids while controlling the rate at which water is added. Final products are disclosed as having a moisture level of less than 0.5 wt %. It is disclosed in column 5 that small amounts of a vinylpyrrolidone-vinyl acetate copolymer does not adversely affect the process and that the process does not require the use of surfactants or binding agents.

U.S. Pat. No. 5,464,623 teaches two processes to pelletize phosphoroamido(di)thioates. One process uses a solvent for the technical grade compound to make a pourable or extrudable mixture. The list of preferred solvents include hexane, carbon tetrachloride, toluene, isopropanol, ethanol, chloroform, methanol, and methylene chloride. The other process melts the technical grade compound at about 90° C. for subsequent molding or spraying into droplets. Useful pellets are described as “extrudates of about 3 mm to 25 mm in length with diameters from about 1.5 mm to 7 mm.” Spherical pellets are also described with diameters of about 1 mm to 5 mm.

Melt-forming of technical acephate and compositions containing technical grade of acephate would provide a number of advantages. Unfortunately, long term stability tests on melt-formed pellets have shown unacceptable levels of degradation after an unacceptably short period of time.

It would be desirable to have a process for melt-forming of acephate and other phosphoroamido(di)thioate materials that would provide a water soluble pellet having a long term stability against unacceptable levels of degradation of the active ingredient.

### SUMMARY OF THE INVENTION

It is an object of the invention to provide a process for making phosphoroamido(di)thioate containing pellets in a form suitable for use as an effective insecticide.

It is a further object of the invention to provide a process for making phosphoroamido(di)thioate pellets that can be readily modified to produce pellets of differing forms.

In accordance with these and other objects of the invention that will become apparent hereafter, a process for making phosphoroamido(di)thioate pellets includes (a) melting the phosphoroamido(di)thioate technical under a substantially oxygen-free atmosphere and (b) forming the molten phosphoroamido(di)thioate into pellets of a form useful as an insecticide.

Pellets formed according to the present invention exhibit superior long term stability against degradation of the active ingredient. While not wishing to be bound by theory, it appears that the substantial absence of oxygen during the melting and forming steps prevents or inhibits oxygen from becoming entrapped or entrained within the melt and the resulting solid. Further, control over the ambient atmosphere of the melting environment allows for the substantial exclusion of ambient moisture from the melt environment and from entrainment within the molten acephate. It is believed that this entrapped oxygen and potentially entrapped water molecules may be responsible for catalyzing or accelerating the degradation of active ingredient upon extended storage. The present manufacturing process, and the formed pellet that results therefrom, allows phosphoroamido(di)thioate pellets to be produced in a wide variety of shapes and forms while exhibiting superior and commercially acceptable storage stability.

The features of the invention are basically attained by providing a method for forming crystalline powder containing technical grade N-hydrocarboyl phosphoroamido(di)thioate solids into particles. The crystalline powder is melted at a temperature above about 90° C. to 100° C. in a substantially oxygen-free atmosphere for a time sufficient to melt said N-hydrocarboyl phosphoroamido(di)thioate solids to a fluid melt having a free-flowing viscosity at 95° to 100° C. that is similar to refined or light mineral oil. The fluid melt is then simultaneously or sequentially cooled and formed into particles.

The features of the invention are further attained by providing a method of forming a particulate insecticide composition. The method comprises the steps of: (a) heating a crystalline powder of technical grade N-hydrocarboyl phosphoroamido(di)thioate to a temperature sufficient to form a melt in a substantially oxygen free atmosphere; and (b) forming and cooling the melt to form solidified particulates containing insecticidally active N-hydrocarboyl phosphoroamido(di)thioate.

The features of the invention are yet further attained by providing a method of forming a particulate insecticide composition. The method comprises the steps of: (a) heating a mixture of technical grade acephate and a nonreactive diluent in a substantially oxygen free atmosphere to form a substantially homogeneous melt; and (b) forming and cooling the melt to obtain solidified discrete insecticidal particulates containing acephate.

These and other aspects of the invention will become apparent from the following detailed description of the invention which disclose various embodiments of the invention.

### DETAILED DESCRIPTION OF THE INVENTION

Phosphoroamido(di)thioate insecticides are formed, according to the invention, by a process that includes (a) melting an insecticidal formulation comprising insecticidally active phosphoroamido(di)thioate under substantially oxygen-free conditions to form a fluid melt having a substantially free-flowing viscosity, and (b) forming the fluid melt into particles (e.g., pellets, granules, prills, flakes, etc.) of an agriculturally useful shape and size.

Acephate is a particularly preferred insecticide for use in the present invention, and description of the present process is conveniently described with reference to this particular active ingredient. It will be understood, however, that reference to this specific active ingredient in the following description is also intended to refer to the general class of insecticidally active phosphoroamido(di)thioate compounds.

Acephate is commercially available in a technical grade solid of at least 97 wt % purity. The acephate technical is preferably used in the pellet in an amount corresponding to the active ingredient concentrations used in the commercially available powder and granular formulations. Such formulations generally have active ingredient concentrations of about 70-75 wt %, 90-93 wt %, and ≧97 wt % as well as other concentrations that depend on the intended final use. Preferably, the acephate technical is used in an amount of at least 85 wt % and preferably about 90-93 wt % based on total weight of the dried pellet.

The melting step of the present process can be accomplished by substantially any equipment that has the ability to produce sufficient heat to melt phosphoroamido(di)thioate technical grade solids, e.g., above about 90° C., preferably a temperature within the range from about 90° C. to about 100° C., and even more preferably within the range from about 95° C. to about 100° C. Suitable equipment for melting the solids includes an oven of any type (convection, infrared, microwave, induction, etc.) that is above or around a heat resistant conveyor system, an extruder with a suitably shaped die, an agitated and heated chamber that can receive screw-fed solids and discharge a molten liquid, or similar apparatus.

The melting step of the invention preferably heats the insecticide formulation for a time sufficient to completely melt the phosphoroamido(di)thioate to a free flowing liquid state and without excessive heating which could cause decomposition. The heating is substantially in the absence of oxygen or in an atmosphere having a sufficiently low oxygen content (e.g., substantially at impurity levels or less) to inhibit entrainment of oxygen that can cause degradation of the active ingredient.

A conventional extruder can be used if it is operated under the present restrictions on ambient oxygen around the zone from where the insecticide is introduced into the extruder until its ejection as an extrudate. Conventional extrusion of insecticide solids does not completely melt the active ingredient, but rather, heats the surfaces of the particles to enable the particles to fuse together as they are compacted by their passage through the extrusion nozzle. Exclusion of oxygen contact and entrainment during the melting and fusing process will provide similar enhancements of storage stability as with a fully molten processing.

The conditions for the melting step include a substantially oxygen-free environment. Preferably, oxygen is substantially excluded from a point in the melting process that begins before the phosphoroamido(di)thioate technical is exposed to a substantial increase in ambient temperature, e.g., such as in the loading hopper or point of introduction of the insecticidal solids into the processing equipment. Oxygen is also preferably substantially excluded at least until the molten material is formed into some form of discrete volume that would represent a useful particulate, e.g., pellet, prill, granule, etc.

Preferably, the substantially oxygen-free environment is achieved by melting the phosphoroamido(di)thioate technical in an enclosed, or effectively enclosed, space under an atmosphere of a chemically inert or non-reactive gas. Suitable systems can include a conveyor for moving phosphoroamido(di)thioate technical solids from a storage hopper into an enclosed (or effectively enclosed), heated, agitated chamber that can dispense with a separate metering system or a flow regulating valve. Additionally, a fast moving stream of inert or non-reactive gas from a rectangular exhaust can be used like an “air knife” to provide effective sealing of heating chambers that are otherwise not physically sealed from the ambient air.

It has been found that producing an acephate melt in an oxygen free atmosphere allows the acephate to be processed for longer periods of time in the molten state without degradation or with significantly less degradation than by heating the acephate to a molten state in an oxygen-containing atmosphere. In particular, it has been found that an acephate melt can be processed in a molten state at a temperature of 90° C. to 100° C. for 15 minutes to 30 minutes under an effectively oxygen free atmosphere without substantial or detectable degradation of the acephate and without any reduction of the acephate stability during storage. In some embodiments, the acephate-containing composition can be processed for more than 30 minutes without substantially any detectable degradation.

Suitable chemically inert gases for excluding oxygen from the loading stage through the melt processing stage include nitrogen, carbon dioxide, and one of the noble gases (e.g., helium, neon, argon, krypton, or xenon). The atmosphere in the melt chamber or melting zone is also substantially in the absence of moisture or other gases that may react with the phosphoroamido(di)thioate technical.

The process of the present invention preferably melts the acephate to form agrochemically useful particles (e.g., prills, granules, pellets or flakes) from the crystalline insecticide, with or without prior processing for de-lumping and agglomerate size reduction. The process heats the acephate to a temperature sufficient to melt the acephate completely in an effectively oxygen free atmosphere and then forms the molten acephate composition into the desired particle of the desired size before, during, or after cooling to solidify the acephate.

The cooling or quenching step can be by any suitable means that is able to solidify the melt without contaminating or decomposing the acephate. Preferably, the cooling step uses dry, relatively cooler gas that is either substantially oxygen free or which may contain substantial amounts of oxygen, such as ambient air. Since the acephate is melted to a temperature slightly above the melting point and cools relatively quickly following particle formation for most agrochemically useful particle size ranges, cool air is generally sufficient to solidify the acephate without causing degradation. Preferably, the acephate is cooled as quickly as possible and contacts cooled surfaces during the processing. It is particularly desirable to minimize contact of the acephate melt with heated surfaces to minimize degradation.

Preferably, the molten acephate is cooled by air under conditions where air does not become entrained in the molten acephate. For example, the molten acephate can be deposited on a conveyor belt or other cooled surface that can quench the acephate quickly without entrapping air in the molten acephate. The conveyor belt can have recesses or indentations that are relatively cooler or actively cooled so as to form small, uniform briquettes of insecticide as the insecticidal mixture cools and solidifies.

In the formation of prilled acephate, molten acephate is ejected from a spinning device into contact with a cone or curtain that is located a distance away. By adjusting the distance of the curtain and temperature of the prilling chamber, the amount of cooling of the acephate composition is used to control the shape of the final particle from flattened disks (curtain contact after less than complete cooling) to spheres (high degree of cooling before curtain contact).

In one embodiment, the N-hydrocarboyl phosphoroamido(di)thioate is blended with a filler or solid diluent (such as a maltodextrin or silica) and then fed onto a conveyor belt. The conveyor belt passes through a heating chamber to heat the mixture to form a melt while maintaining a substantially oxygen free atmosphere within the heating chamber. The heating chamber preferably heats the mixture to a temperature of about 90° C. to 100° C., preferably about 95° C. to 100° C., until the acephate insecticide is melted to a free flowing viscosity.

Once the insecticide mixture is melted, the melted mixture exits the heating chamber and is quickly cooled or quenched with cool, dry air to solidify the insecticide mixture. It has been found that rapid cooling of the insecticide melt can be carried out in air to solidify the mixture without causing decomposition of the insecticide. Cooling can be carried out by directing a downward flow of air onto the conveyor belt to solidify the insecticide directly on the belt into solid particles larger than the initial feed. Preferably, the resulting melted and solidified insecticide has substantially no particle sizes that are easily airborne.

The solidified insecticide is removed from the conveyor belt by a suitable means such as by scraping and transferred to a flake chipper. The chipper reduces the particle size to about 150 μm to about 4000 μm, (for flakes, a range is preferably about 250 μm to about 4000 μm) depending on the desired dissolution rate. The flaked product is then classified to recover the desired particle size with the fines and the oversized particles being recycled to the initial feed.

In another embodiment, a diluent and optional odor masking agent are supplied to a mixing apparatus to form a mixture with the incoming insecticidal solids. The resulting mixture (insecticide+diluent+masking agent) is conveyed to a closed melting chamber operating in a nitrogen atmosphere. The insecticide mixture is melted in the nitrogen atmosphere with continuous mixing. The melt of the insecticide mixture is dispensed through a nozzle or metered onto a rotating centrifugal disk for prilling the mixture. The rotating disk is maintained in a cooling zone supplied with cooled or chilled air so that the molten insecticide mixture contacts the rotating disk and forms droplets of the molten insecticide which are thrown radially outward through the cooling atmosphere to solidify. Typically, the droplets are directed outwardly from the rotating disk to contact an outer surface of or a curtain in the cooling chamber where, depending on distance and degree of solidification, may form a spherical or flattened disk particulate. The resulting particles are collected from the cooling chamber and classified. The fines and oversized particles are separated and recycled.

The diluent is preferably a solid particulate that can aid in particle formation, distribution during use or solubilization during use of the finished insecticide. In one preferred embodiment, the mixture of the active ingredient and diluent is substantially in the absence of an aqueous solvent. The mixture is also preferably heated in a dry atmosphere that is substantially in the absence of oxygen. The resulting melt is preferably cooled and solidified in a dry atmosphere.

Particles made by the present invention, regardless of shape or size, are preferably dried to a residual moisture content of less than about 1 wt %, more preferably less than about 0.5 wt %, for enhanced long term storage stability. Any form of drying process can be used, e.g., forced air, convection oven, fluid bed, and the like.

For highest storage stability, it would be preferred to dehumidify the insecticidal solids before introducing them into the controlled atmosphere melt chamber. Such an additional process step is intended to remove the substantial portion of any adsorbed or absorbed water molecules that may have become associated with the insecticidal solids during one or more preliminary size reduction steps.

### Optional Masking Agent

In a preferred embodiment, the pellets formed by the present invention are contacted with an effective amount of a masking agent that, at relatively low concentrations, has the ability to mask the human perception of sulfurous odors that are traditionally associated with a field that has been recently treated with phosphoroamido(di)thioate insecticides such as acephate. Suitable masking agents are described in Published U.S. Patent Application 2003/0153484 filed Feb. 8, 2002, the disclosure of which is herein incorporated by reference.

Briefly described, the masking agents useful with pellets of the present invention comprise one or more volatile terpene or their oxygenated derivatives that mask at least a substantial portion of the offensive odors from the active ingredient when formulated into a solid granule, mixed into solution, or blended on a solid carrier with a powdered active ingredient, or sprayed onto a co-applied or previously applied active ingredient.

Terpenes are unsaturated hydrocarbons which are based on the isoprene unit of alternating double bonds. Terpenes of preferred use in the invention include citral, camphor, alpha- and beta-pinene, terpineol, limonene, alpha- and beta-terpinene, alpha- and beta-phellandrene, cedrene, geraniol, linalool, neral and abietic acid. Especially preferred terpenes include citral, camphor, alpha- and beta-pinene, terpineol and limonene.

Another source or aromatic terpene are naturally-occurring or synthesized versions of “essential oils”. Essential oils are the volatile, aromatic oils obtained by steam or hydro distillation, solvent extraction of botanical sources, pressing of rinds, maceration of flowers and/or leaves in fat and then by solvent extraction of the fat, and enfleurage. Different parts of the plants can be used to obtain essential oils, including the flowers, leaves, seeds, roots, stems, bark, wood, etc. Certain cold-pressed oils, such as the oils from various citrus peels, are also considered to be essential oils. Other aromatic, plant-derived oils are solvent extracted and include Absolutes (hexane followed by ethanol extraction), CO₂ extraction (liquid carbon dioxide used as the solvent) and Phytols or Florosols (fluoro-hydrocarbon solvent). Appropriate definitions are found in Grant & Hackh's Chemical Dictionary, 5th ed., p. 219 (1987) and Hawley's Condensed Chemical Dictionary, 11th ed. pp. 471-472 (1987) which are incorporated herein by reference to the extent that these definitions are not inconsistent with the disclosure herein.

Essential oils can be synthesized and exist naturally in plants and impart the characteristic odors to flowers, leaves, or woods. They also exist primarily as terpenes (oil of turpentine, juniper, etc) but may be developed from plant constituents by enzyme action or heat. Essential oils are flammable, soluble in alcohol or ether, slightly soluble in water and can contain hydrocarbons, alcohols, phenols, ethers, aldehydes, ketone, and acids. Essential oils are volatile, not greasy, and are unsaponifiable (except for those containing esters). Some essential oils are nearly pure single compounds, e.g., oil of wintergreen (methyl salicylate). Others are mixtures, e.g., turpentine oil (pinene+dipentene) and oil of bitter almond (benzaldehyde+hydrocyanic acid). Those essential oils that contain resin in solution are also called oleoresin or balsams.

Essential oils generally have a boiling point of less than about 150° F. Most essential oils are primarily terpenes and their oxygenated derivatives, e.g., terpene, sesquiterpene, monoterpenol, sesquiterpenol, aldehyde, ketone, ester, etc. While the principle components are mono- to tetra-unsaturated olefin terpenes, essential oils may also contain benzenoid and aliphatic compounds as well including alcohol, ether, carbonyl, etc. functionality. Preferred essential oils can also include such aldehydes as benzaldehyde and cinnamaldehyde. Highly preferred essential oils smell like citrus fruits (orange, lemon, lime, a mixture of lemon and lime, etc.) and pine oil. Specific chemical structure information for the essential oils is available at http://www.essentialoils.org in their chemical reference database, the contents of which is hereby incorporated by reference. A particularly preferred essential oil for use with acephate solids is a lemon fragrance sold by Arrlessence in Atlanta, Ga. USA under the designation “G4136 Lemon Oil” or “AA045486 Lemon”. Especially preferred for use are those essential oils that are considered by the USEPA to be “generally regarded as safe” (GRAS).

Essential oils should not be confused with cold-pressed fixed or carrier oils like olive, grapeseed, apricot kernel, etc. Such carrier oils are non-volatile oils composed mainly of fatty acid triglycerides and do not have sufficient volatility or concentration of volatile components to act as an effective masking agent for the phosphoroamido(di)thioate solids according to the present invention.

The masking agent of the present invention is preferably anhydrous, but may also be used as an emulsion, in an encapsulated form, or either absorbed or adsorbed within a suitable adsorbent or absorbent solid.

The masking agent can be combined with the insecticidally active ingredient in virtually any method that allows the masking agent to volatilize with the emission of any noxious odors from the overall formulation. For example, liquid masking agent can be contacted with the crystalline active ingredient solids before the present forming process; sprayed, poured, or mixed with the insecticidally active pellets during or after the formation process; dispersed over the active ingredient-containing solids that are distributed at the same time or which were previously distributed or which will be distributed into the treated area; or the masking agent can be mixed with a solid carrier or other liquid formulation containing the active ingredient. Conventional equipment can be used: spray nozzles, metering devices, extrusion screws, mixing paddles and the like.

### Other Ingredients

A variety of other ingredients can be added to the active ingredient of the invention. An exemplary list of materials includes a suitable diluent for the pellet that may or may not serve a secondary function when the pellet is dissolved, and an anticaking agent such as fumed silica. Other environmentally acceptable additives as known in the art can also be used. For example, suitable additives can include ammonium sulfate, magnesium sulfate, dehydrating agents, surfactants, deodorants, and the like. The diluents can include, for example, hexane, isopropanol, ethanol, and methanol.

An anticaking agent can be added, if desired, in an amount sufficient to prevent clumping and caking during the processing and extruding of granules. Generally no more than about 3 wt % is needed. Silica powder in an amount within the range of 0.5-1.25 wt % is particularly useful as an anticaking agent. If the silica is used as a diluent or solid carrier for a masking agent, an amount within the range of 2-10 wt % is particularly useful.

Stabilizing agents can also be added to extend the useful life of the insecticide. The stabilizing agents are used in amounts of less than about 5 wt % and typically in amounts of less than 2 wt %.

### EXAMPLES

### Example 1

In this example, acephate is flaked to produce a stable acephate flake that can be dissolved or dispersed in a solvent for use according to standard procedures. A mixture is formed containing 92 wt % Acephate Technical and 8 wt % Maltrin M-100 (maltodextrin). The mixture can be supplied to a blender having a variable speed screw feeder. The mixture is fed onto a conveyor belt which passes through a heating chamber to heat the mixture to about 90° C. to melt the acephate under a nitrogen atmosphere. The conveyor belt then passes through a cooling chamber where the acephate mixture is cooled to solidify the mixture. The cooling chamber can cool the acephate mixture by directing dry cooled air or by directing a flow of an oxygen-free atmosphere over the acephate mixture. The conveyor belt can have a series of indentations or grooves to form frangible points or lines to assist in forming uniform particle sizes.

The cooled and solidified acephate mixture is removed from the conveyor belt and transferred to a flake chipper to flake or granulate the acephate mixture. The flaked acephate mixture is classified to recover a product having a particle size of about 150 μm to about 4000 μm. The resulting product is stable and readily dissolved for agricultural use.

### Example 2

The process of Example 1 is repeated using 92.0 wt % acephate technical, 7.0 wt % silica available under the tradename HI-SIL 233 and 1.0 wt % lemon oil 4136 (masking agent). The resulting product was stable and readily dissolved or dispensed for agricultural use.

While various embodiments have been chosen to illustrate the invention, it will be understood that various changes and modifications can be made without departing from the scope of the invention as defined in the appended claims.

What is claimed is:

1. A method for forming agrochemically effective insecticidal particles containing N-hydrocarboyl phosphoroamido(di)thioate with a process comprising the steps of:
melting N-hydrocarboyl phosphoroamido(di)thioate solids at a temperature above about 90° C. in a substantially oxygen-free atmosphere for a time sufficient to melt said N-hydrocarboyl phosphoroamido(di)thioate solids; and
cooling and forming the melted solids into agrochemically useful particles.

2. A method according to claim 1, wherein said substantially oxygen-free atmosphere consists essentially of nitrogen, carbon dioxide, or a noble gas.

3. A method according to claim 1, wherein said substantially oxygen-free atmosphere consists essentially of nitrogen.

4. A method according to claim 1, wherein said particles are in the form of prills, flakes, or shaped briquettes.

5. A method according to claim 4, wherein said prills exhibit an average diameter within the range from about 150 μm to about 4000 μm.

6. A method according to claim 4, wherein said flakes exhibit a particle size distribution within the range from about 250 μm to about 4000 μm.

7. A method according to claim 1, wherein said N-hydrocarboyl phosphoroamido(di)thioate solids comprise acephate.

8. A method according to claim 1, wherein said process further comprises spraying a masking agent comprising an essential oil onto said particles.

9. A method according to claim 8 wherein said essential oil has the smell of a citrus fruit.

10. A method according to claim 9 wherein said essential oil has the smell of lemon.

11. A method according to claim 1, wherein the melting step comprises:
melting the crystalline powder in a closed mixing chamber and dispensing the fluid melt onto a rotating disk to form a prill.

12. A method according to claim 1, wherein the crystalline powder is melted by heating to a temperature of about 90° C. to about 100° C.

13. A method according to claim 1, wherein the crystalline powder is melted at a temperature of about 95° C. to about 100° C.

14. A method according to claim 1, wherein the crystalline powder is heated for not more than 30 minutes at a temperature within the range of 90° C. to 100° C.

15. A method of forming a particulate insecticide composition, said method comprising the steps of:
heating N-hydrocarboyl phosphoroamido(di)thioate solids to a temperature within the range of about 90° C. to about 100° C. in a substantially oxygen free atmosphere; and
forming the heated N-hydrocarboyl phosphoroamido(di)thioate into solidified insecticidal particles.

16. The method of claim 15, wherein said N-hydrocarboyl phosphoroamido(di)thioate is acephate.

17. The method of claim 16, wherein said acephate is formed into a prill, flake, or briquette.

18. The method of claim 15, wherein said acephate is heated to a temperature within the range of 90° C. to 100° C. for not more than about 30 minutes.

19. The method of claim 15 further comprising the steps of:
loading said N-hydrocarboyl phosphoroamido(di)thioate solids onto a conveyor system in a substantially oxygen free atmosphere, and conveying said N-hydrocarboyl phosphoroamido(di)thioate solids into a heating zone.

20. The method of claim 19 further comprising:
removing adsorbed moisture from said N-hydrocarboyl phosphoroamido(di)thioate solids while conveying said N-hydrocarboyl phosphoroamido(di)thioate solids into said heating zone.

21. The method of claim 15, wherein said particulate insecticide has a particle size of about 150 μm to about 4000 μm.

22. The method of claim 15, wherein melt N-hydrocarboyl phosphoroamido(di)thioate is dispensed onto a rotating disk in a cooling atmosphere to form a prill.

23. The method of claim 15, wherein melted N-hydrocarboyl phosphoroamido(di)thioate is produced on a conveyor belt in depressions formed into said belt.

24. The method of claim 15, wherein said N-hydrocarboyl phosphoroamido(di)thioate is heated to a free flowing fluid melt in an atmosphere selected from the group consisting of nitrogen, carbon dioxide, a noble gas and mixtures thereof.

25. Insecticidal particles containing N-hydrocarboyl phosphoroamido(di)thioate made according to the method of claim 15.

26. Insecticidal prills containing acephate made according to the process of claim 22.

27. Insecticidal briquettes containing acephate made according to claim 23.
